(19) United States
(12) Patent Application Publication
(10) Pub. No.: US 2021/0081592 A1
(43) Pub. Date: Mar. 18, 2021

(54) SIMULATION CORRECTION USING MEASUREMENTS AND DEEP LEARNING

(71) Applicant: Tektronix, Inc., Beaverton, OR (US)

(72) Inventors: Jonathan S. Dandy, Portland, OR (US); Brian S. Mantel, Tigard, OR (US)

(21) Appl. No.: 17/024,529

(22) Filed: Sep. 17, 2020

Related U.S. Application Data
(60) Provisional application No. 62/901,754, filed on Sep. 17, 2019.

(51) Int. Cl. G06F 30/367; G06N 20/00; G06F 119/08

(52) U.S. Cl. CPC G06F 30/367; G06F 2119/08; G06N 20/00

(57) ABSTRACT

A method for improving the accuracy of simulation models can include measuring a characteristic value at one or more nodes of a physical embodiment corresponding to the simulation model; inputting the measured characteristic value into a trained machine learning facility corresponding to the simulation model; and receiving from the trained machine learning facility one or more predicted values based at least in part on the inputted measured characteristic value.

### PRIORITY

This disclosure claims the benefit of U.S. Provisional Application No. 62/901,754, titled “SIMULATION CORRECTION SYSTEM,” filed on Sep. 17, 2019, which is incorporated herein by reference in its entirety.

### FIELD OF THE INVENTION

This disclosure is directed to test and measurement instruments, and more particularly to systems and methods for comparing device measurement data from a test and measurement instrument to simulation data for the device, and correcting the simulation data.

### BACKGROUND

Simulation models corresponding to a device under test (DUT) as well as the actual measurements from a DUT are important design tools for engineers. A simulation model produces mathematically generated predictions of circuit operation for a given circuit design. Actual measurements from a DUT may be made by test and measurement instruments such as an oscilloscope. With presently-used systems, however, the simulation model and the actual measurements are often in disagreement with each other.

Conventional tools related to circuit simulation and analysis include a Serial Data Link Analysis (SDLA) tool that can be used to model a transmission channel for high-speed-serial applications. The SDLA tool can correct waveforms and display waveforms that are not accessible to the user; however, any model errors compromise the model results. An expert user is often necessary to refine the model to achieve consistent results with the measurement.

Other conventional tools include specialized software that can analyze measured Time Domain Reflectometer (TDR) data to generate a model of transmission line lengths, impedances, and discontinuities, for example; however, these tools apply for specific circuit topologies and do not address the various model-to-measurement inconsistency issues.

Embodiments of the disclosure address these and other deficiencies of the prior art.

### BRIEF DESCRIPTION OF THE DRAWINGS

Aspects, features and advantages of embodiments of the present disclosure will become apparent from the following description of embodiments in reference to the appended drawings in which:

FIG. 1 is a flow diagram illustrating an example of a method for training a machine learning facility to create an improved simulation model in accordance with certain implementations of the disclosed technology.

FIG. 2 is a flow diagram illustrating an example of a method for predict or infer a set of revised model parameters that better match a measured result, in accordance with certain implementations of the disclosed technology.

FIG. 3 is a block diagram illustrating an example of a test and measurement system in accordance with certain implementations of the disclosed technology.

### DETAILED DESCRIPTION

Implementations of the disclosed technology generally include systems and methods capable of improving predicted results of a simulation model.

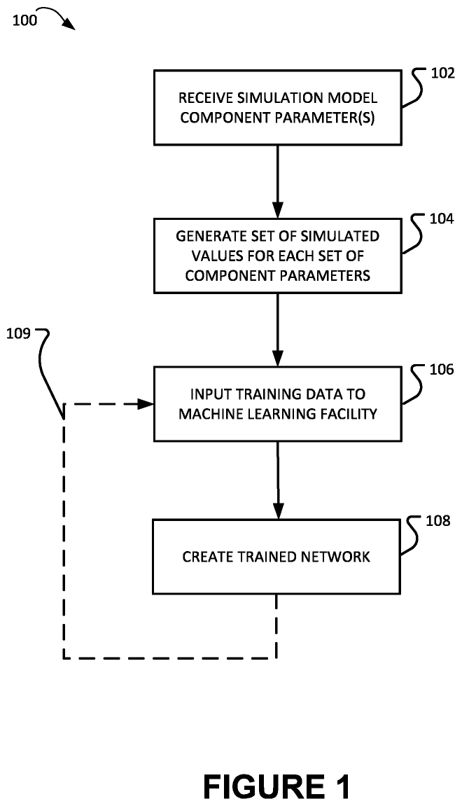

FIG. 1 is a flow diagram illustrating an example of a method 100 for training a machine learning facility to create an improved simulation model in accordance with certain implementations of the disclosed technology.

At 102, information pertaining to one or more parameters of individual components of a simulation model is received. In some embodiments all of the individual components are used, while in other embodiments only some of the individual components of a circuit simulation are used. The individual components may include, but are not limited to, a resistor, a transistor, a capacitor, an inductor, a diode, an operational amplifier, a voltage source, a current source, and a transmission line. The parameters for the individual components may include, for example, resistance, current, impedance, temperature coefficient, parasitic capacitance, transmission line length, transmission line width, material dielectric constant, and geometry. As described below, embodiments of the invention are applicable to many types of simulation models, and the circuit simulation model described with reference to the figures is only one example.

At 104, a dataset of generated values are combined into a simulation result value for each of the simulation model component parameters. The inputs to the simulation may include values for the parameters of the individual components in the circuit identified in operation 102, and the output of the simulation may include a very large dataset of individual instances of the inputs to the simulation along with simulated circuit outputs. The instances may be likened to rows of a spreadsheet, whereas the columns of such a spreadsheet would represent the values of the component parameters themselves, as well as outputs predicted through simulation. There may be any number of instances in the dataset, and typically the greater number of instances improves the performance of the machine learning. One example dataset may include millions of instances. In addition to component parameters, the dataset may include simulated test data for a circuit made of the component values of the particular instance.

For example, in an overly simplified example of a resistor network having three resistors, each instance may include resistance parameter values for each of the three resistors, a signal input to a node of the circuit, as well as simulated (i.e., generated) values for current and voltage at three different nodes within the circuit that includes the resistor network. The simulated values for current and voltage at the nodes are generated by the model based on the input signal. In the context of this example, since the resistance parameter is the primary parameter of interest for this simple resistor network, the following discussion of this example will use the terms “resistance value” and “resistor value” interchangeably with “resistance parameter value.” Simulated values may include waveforms, and need not be static values. That is, a simulated value in some embodiments may be a collection of values as they change over time. In certain implementations, the waveforms may undergo a data reduction procedure such as, for example, reducing a waveform to a smaller set of waveform attributes. Also, the simulation may predict values for any of the nodes within the circuit, and is not limited to any particular number. Further, many different simulated values may be produced for the instances of the simulation, which may be related to the parameters of the individual components described above with reference to the model component parameters.

For a three-dimensional (3D) electromagnetic simulation, the model parameters can include—but are not limited to—line widths, material dielectric constants, and other geometries that may vary in manufacturing. Other simulation domains such as mechanical and thermal, for example, are also compatible with this approach provided the measured data corresponds to outputs from the simulation.

For a Serial Data Link simulation, the model parameters may include—but are not limited to—transmitter and receiver equalization, s-parameters, impulse response, other filter responses, inter-symbol interference, and analog model characteristics, for example.

Other models that may benefit from embodiments of the invention include those from mechanical and thermal simulation domains by correlating measured data to simulated output data and modifying such models to better predict actual measured values.

In certain embodiments, the input parameters for the dataset may be bound within a range of values. For example, the values of the resistance parameter for each of the three resistors in the above example may be bound between 100 Ohms and 1000 Ohms when generating the training dataset.

During the simulation, i.e., the generation of the dataset produced in the operation 104, the simulation may create instances by varying the resistance values for each of the three resistors independently, as well as simulate and store output values for the various testing nodes within (or at the endpoints of) the resistor network. Each particular instance of the generated dataset may have at least one different component parameter value from every other instance. For instance, for the first generated instances, the resistance values for resistor 1 (R1) and resistance resistor 2 (R2) may be held static, while resistance values for resistor 3 (R3) may be changed, for each instance, between 100 Ohms and 1000 Ohms in steps of ten Ohms. The first four instances of such a dataset are illustrated in the Example dataset shown in Table 1.

TABLE 1

| | | | | Node 1 | Node 2 | Node 3 | | R1 Pin 1 |
|---|---|---|---|---|---|---|---|---|
| | | | | Predicted | Predicted | Predicted | | Predicted |
| Instance | R1 value | R2 value | R3 value | voltage | Voltage | Voltage | | Current |
| 1 | 100 Ohm | 150 Ohm | 100 Ohm | 2.2 v | 1.1 v | 4.8 | v | 50 μA |
| 2 | 100 Ohm | 150 Ohm | 110 Ohm | 2.2 v | 1.7 v | 4.85 | v | 50 μA |
| 3 | 100 Ohm | 150 Ohm | 120 Ohm | 2.2 v | 1.9 v | 4.9 | v | 50 μA |
| 4 | 100 Ohm | 150 Ohm | 130 Ohm | 2.2 v | 2.3 v | 4.95 | v | 50 μA |

The inputs to the value simulator may be manually produced or generated according to an algorithm, for example. Recall that the inputs in the above example are the resistance values for R1, R2, and R3. The various combinations of the resistance values, within the bound limits set for the input parameters as described above, may be generated by hand or by machine. For example, a looping program could be set to step each of the resistance values through a loop progression from its minimum to maximum value so that all possible combinations are generated as individual instances. In other examples, a Monte Carlo process could be used to generate the particular component parameter input values for each instance within their value bound limits. The input values may also be randomly generated.

The simulator accepts the input values and, at operation 104, uses a circuit simulator to generate simulated output values that are stored in the particular instance that was used to generate the output values. The output values simulated by the simulator and stored in the dataset in operation 104 may include current, voltage, etc., as shown in Table 1. In some embodiments the simulated output values may also include waveforms of particular testing nodes of the network at particular times. As described below, there may be a large number of values generated for each instance in the dataset, and such values are not limited to merely current and voltage as shown in Table 1. In some embodiments the output values may be determined in the time domain, while in other embodiments the output values may be determined in the frequency domain.

At 106, a training dataset that includes the simulation model component parameters from operation 102 and the corresponding simulated values produced in operation 104 are provided as training data input to a machine learning facility. Table 1 may be considered an overly simplified training dataset for explanation purposes. In reality the dataset may have thousands or millions of instances (rows) and hundreds or thousands of columns representing model component parameters and the values simulated therefrom. In some embodiments multiple values are specified for each component in a circuit network, which may include hundreds of components. Each of the individual components may have values in the dataset for resistance, impedance, temperature coefficient, parasitic capacitance, transmission line length, transmission line width, material dielectric constant, and geometry, for example. Any desired output that may be generated from the circuit simulator may be stored as a value (column) in each instance.

After the machine learning facility receives its training data in operation 106, the trained network is created in operation 108. In operation 108, for example, a neural network may read the inputs from the first instance and generate a predicted outcome. Then the neural network compares its generated predicted outcome to the data used to create the simulated results, also included in the instance, and uses back propagation to modify weights and biases within the neural network so that its next prediction will be closer to the original data value. In the example of Table 1, the inputs to the network are the simulated results (Node 1 Predicted voltage, Node 2 Predicted Voltage, etc.), and the predicted output is a predicted value for R1, R2, and R3, which is compared, during training, to the original values of R1, R2, and R3 that were used to create the simulated results. The training continues progressing through all of the instances until the network is fully trained. In some embodiments the training makes multiple passes through the training database, as indicated through the optional loopback 109. In some embodiments the neural network may change the order of the instances as they appear in the training dataset to avoid training biases.

Operation 108 may use supervised machine learning or unsupervised machine learning. Supervised machine learning as used herein generally refers to machine learning that is based upon training sets that contain labeled data. Unsupervised machine learning generally refers to ‘learning’ on training sets that contain mostly unlabeled data to train the neural network. The machine learning facility may apply a particular technique, such as a Bayesian approach, Random Forest, regression models, or classification models.

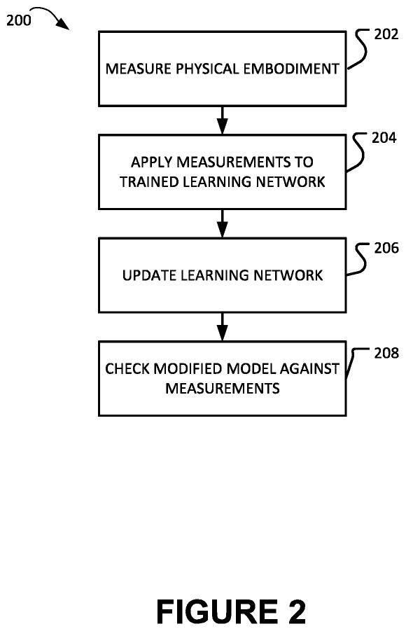

FIG. 2 is a flow diagram illustrating an example of a method 200 for predicting or inferring a set of revised model parameters that better match a measured result, in accordance with certain implementations of the disclosed technology.

A physical embodiment, such as a suitable device under test (DUT), may be measured in an operation 202. The physical embodiment may correspond, for example, to a circuit model previously used for simulation as described above. In measuring the physical embodiment in operation 202, the user may use a test probe to make actual physical connections to one or more test points on the DUT (e.g., nodes, lines, traces, pins, or individual components) and then acquire actual data, waveforms, or measurements from the DUT.

Once these measurements are obtained, the measurements acquired in operation 202 may be applied to the trained learning network, in an operation 204, to predict or infer a set of revised simulation model parameters that better match the measured result than the original predicted model. In certain implementations, the measured data may be manipulated to account for measurement uncertainty and reflect a set of possible measurements. For example, if the DC gain of a certain measurement had a ±2% accuracy, then signals that were up to 2% higher and up to 2% lower could be stored as an additional training set or as additional instances of the original training set. The machine learning network could then be improved (i.e., updated or retrained) in an operation 206 with the additional instances or new training dataset as described above. The result after re-training the machine learning network in operation 206 would be a set of nominal model parameters, each of which would have a certain range of uncertainty due to measurement errors.

In another aspect of the system, the trained learning network includes an ability to add a previously unspecified component to the model, and is not limited to merely adjusting parameters of an existing model.

The original simulation model may then be updated with revised model parameters generated by the updated learning network, and then re-run to, in an operation 208, compare the revised model output values against the set of measured values as measured in operation 202. If successful, the updated simulation model will better match the actual measurements than the original simulation model.

If the physical embodiment, such as a circuit, is not working as expected, the updated simulation model may generate possible insight into what is different from the intended design, as well as which parameters may be contributing to these differences. The adjusted simulation model may also provide a validated starting point for design revisions.

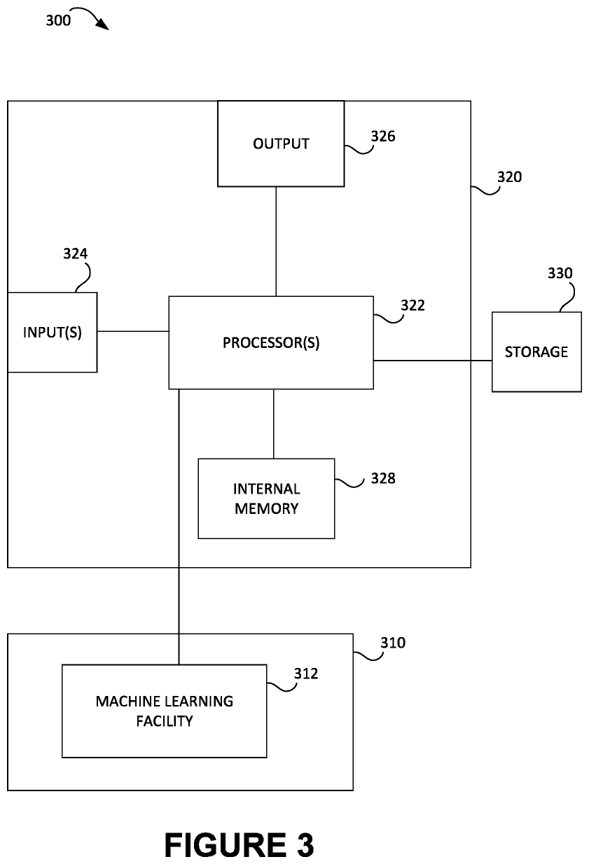

FIG. 3 is a block diagram illustrating a computing system 300 upon which certain implementations of the disclosed technology may be executed. The computing system 300 may be general purpose or special purpose. In one example, the computing system 300 is a test and measurement system. In the example, the system 300 includes a computing device 320, such as a test and measurement device 320. In one embodiment the test and measurement device may be an oscilloscope. The system 300 also includes a machine 310 that hosts a machine learning facility 312 configured to use supervised or unsupervised machine learning techniques. In an example embodiment the machine 310 is a computing device and the machine learning facility 312 may be a set of computer operations and memory operating on the computing device. The machine 310 may be local or remote to the computing device 320. The machine 310 may be a virtualized machine operating in a computer network cloud, for instance.

The computing device 320 has at least one processor 322, at least one input 324, and an output 326, such as a display device or other output. In the example, the computing device 320 also has an internal memory 328. In certain implementations, the system 300 further includes an external storage device 330 such as a remote server, for example. The input 324 may be structured to receive measurement data either directly from a measurement or data extracted from another measurement device. The input 324 may also be structured to receive data that has been previously stored or data from an information cloud.

Either or both of the internal memory 328 and the external storage 330 may store a simulation model, such as a circuit simulation model. The processor(s) 322 of the computing device 320 may be configured to receive information for parameters of certain components of the simulation model, simulate values for each of the simulation model component parameters, and provide them as input to the machine learning facility 312.

The machine learning facility 312 may apply machine learning to the simulated values to generate a predicted value for each inputted parameter and compare the predicted value to its corresponding simulated value. The machine learning facility 312 may adjust the simulation model based on the comparison of the predicted to the simulated values.

Embodiments of the invention may be used for various types of modeling. As mentioned above, embodiments of the invention are useful for improving simulation models.

Implementations of the disclosed technology significantly simplify the design process for general circuits, rapidly improve models, and provide the ability to verify how a device was built. The model refinements can potentially provide expert insight without an expert user. The various novel aspects of the disclosed technology include automatically training a neural network with simulation data and using measured data to inform simulation models.

By combining design intent information from simulations and as-built performance from measurements, a more complete and validated understanding of device performance is achieved. Another application is directed to production tests; in such embodiments, one can use a small set of measurements to indirectly measure sub-circuit parameters with a specified degree of certainty.

In certain implementations, the machine learning network may be trained with data that replaces the nominal circuit with varying possible manufacturing defects (e.g., missing components, shorts across nets, incorrect parts, etc.). In such implementations, one can vary parameters across possible fault values in addition to normal tolerance ranges. The measured data can be fed into a trained neural network to infer failures on a production line based on what defect is likely to be present, for example. Such implementations facilitate automated or semi-automated troubleshooting and corrective action efforts.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the technologies disclosed herein are provided below. An embodiment of the technologies may include any one or more, and any combination of, the examples described below.

Example 1 is a method for adjusting a simulation model, comprising: measuring a characteristic value at one or more nodes of a physical embodiment corresponding to the simulation model; inputting the measured characteristic value into a trained machine learning facility corresponding to the simulation model; and receiving from the trained machine learning facility one or more predicted values based at least in part on the inputted measured characteristic value.

Example 2 is the method of example 1, further comprising modifying at least a portion of the simulation model based at least in part on the one or more received predicted values to generate a modified simulation model.

Example 3 is the method of any one of examples 1-2 further including modifying at least a portion of the modified simulation model based at least in part on another predicted value received from the trained machine learning facility to generate a further modified simulation model.

Example 4 is the method of any one of examples 1-3, further comprising training the machine learning facility.

Example 5 is the method of any one of examples 1-4, in which training the machine learning facility comprises receiving information for at least one parameter of at least one component of the simulation model; and inputting a set of training data to the machine learning facility that includes generated simulated values associated with the at least one parameter of the at least one component of the simulation model.

Example 6 is the method of any one of examples 1-5, in which the set of training data comprises a set of training data created using Monte Carlo simulations.

Example 7 is the method of any one of examples 1-6, in which the simulation model is a circuit simulation model, and wherein the circuit simulation model includes at least one component selected from the group consisting of: a resistor, a transistor, a capacitor, an inductor, a diode, an operational amplifier, a voltage source, a current source, and a transmission line.

Example 8 is the method of any one of examples 1-7, in which the simulation model is a circuit simulation model, and wherein the at least one parameter is selected from the group consisting of: resistance, impedance, temperature coefficient, parasitic capacitance, transmission line length, transmission line width, material dielectric constant, and geometry.

Example 9 is the method of any of examples 1-8, in which modifying at least a portion of the circuit simulation model comprises replacing the simulation model that is stored in a memory with the modified simulation model.

Example 10 is the method of any of examples 1-9, wherein the simulation model is a circuit simulation model, a three-dimensional electromagnetic model, a serial data link simulation model, a thermal simulation model, or a motion simulation model.

Example 11 is the method of any of examples 1-9, wherein the simulation model is a SPICE circuit model.

Example 12 is a test and measurement system, comprising: a machine configured to host a machine learning facility; and a test and measurement instrument having one or more processors configured to: measure a characteristic value at one or more nodes of a physical instance built according to a simulation model; input the measured characteristic value into a trained machine learning facility corresponding to the simulation model; and receive from the trained machine learning facility one or more predicted values based at least in part on the inputted measured characteristic value.

Example 13 is the test and measurement system of example 12, wherein the one or more processors are further configured to improve the simulation model based at least in part on the received predicted value to generate an improved simulation model.

Example 14 is the test and measurement system of any one of examples 12-13, wherein the one or more processors are further configured to: receive information for at least one parameter of at least one component of a simulation model; and input a set of training data to the machine learning facility that includes generated simulated values associated with the at least one parameter of the at least one component of the simulation model.

Example 15 is the test and measurement system of any one of examples 12-14, in which the simulation model is a circuit simulation model, and wherein the at least one parameter is selected from the group consisting of: resistance, impedance, temperature coefficient, parasitic capacitance, transmission line length, transmission line width, material dielectric constant, and geometry.

Example 16 is the test and measurement system of any one of examples 12-15, further comprising a memory configured to store the simulation model.

Example 17 is the test and measurement system of any one of examples 12-16, wherein the one or more processors are further configured to further improve the simulation model based at least in part on the at least one received predicted value for the improved simulation model.

Example 18 is the test and measurement system of any one of examples 12-17, wherein the machine learning facility is structured to operate on one of the one or more processors of the test and measurement instrument.

Example 19 is the test and measurement system of any one of examples 12-18, wherein the machine learning facility is structured to operate a processor separate from the one or more processors of the test and measurement instrument.

Example 20 is the test and measurement system of any one of examples 12-19, wherein the simulation model is a circuit simulation model, a three-dimensional electromagnetic model, a a serial data link simulation model, a thermal simulation model, or a motion simulation model.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

We claim:

1. A method for adjusting a simulation model, the method comprising:
measuring a characteristic value at one or more nodes of a physical embodiment corresponding to the simulation model;
inputting the measured characteristic value into a trained machine learning facility corresponding to the simulation model; and
receiving from the trained machine learning facility one or more predicted values based at least in part on the inputted measured characteristic value.

2. The method for adjusting a simulation model of claim 1, further comprising:
modifying at least a portion of the simulation model based at least in part on the one or more received predicted values to generate a modified simulation model.

3. The method for adjusting a simulation model of claim 1, further comprising:
modifying at least a portion of the modified simulation model based at least in part on another predicted value received from the trained machine learning facility to generate a further modified simulation model.

4. The method for adjusting a simulation model of claim 1, further comprising training the machine learning facility.

5. The method for adjusting a simulation model of claim 4, in which training the machine learning facility comprises:
receiving information for at least one parameter of at least one component of the simulation model; and
inputting a set of training data to the machine learning facility that includes generated simulated values associated with the at least one parameter of the at least one component of the simulation model.

6. The method for adjusting a simulation model of claim 4, in which the set of training data comprises a set of training data created using Monte Carlo simulations.

7. The method for adjusting a simulation model of claim 1, in which the simulation model is a circuit simulation model, and wherein the circuit simulation model includes at least one component selected from the group consisting of: a resistor, a transistor, a capacitor, an inductor, a diode, an operational amplifier, a voltage source, a current source, and a transmission line.

8. The method for adjusting a simulation model of claim 1, in which the simulation model is a circuit simulation model, and wherein the at least one parameter is selected from the group consisting of: resistance, impedance, temperature coefficient, parasitic capacitance, transmission line length, transmission line width, material dielectric constant, and geometry.

9. The method for adjusting a simulation model of claim 2, in which modifying at least a portion of the circuit simulation model comprises replacing the simulation model that is stored in a memory with the modified simulation model.

10. The method for adjusting a simulation model of claim 1, wherein the simulation model is a circuit simulation model, a three-dimensional electromagnetic model, a serial data link simulation model, a thermal simulation model, or a motion simulation model.

11. The method for adjusting a simulation model of claim 10, wherein the simulation model is a SPICE circuit simulation model.

12. A test and measurement system, comprising:
a machine configured to host a machine learning facility; and
a test and measurement instrument having one or more processors configured to:
measure a characteristic value at one or more nodes of a physical instance built according to a simulation model;
input the measured characteristic value into a trained machine learning facility corresponding to the simulation model; and
receive from the trained machine learning facility one or more predicted values based at least in part on the inputted measured characteristic value.

13. The test and measurement system of claim 12, wherein the one or more processors are further configured to improve the simulation model based at least in part on the received predicted value to generate an improved simulation model.

14. The test and measurement system of claim 12, wherein the one or more processors are further configured to:
receive information for at least one parameter of at least one component of a simulation model; and
input a set of training data to the machine learning facility that includes generated simulated values associated with the at least one parameter of the at least one component of the simulation model.

15. The test and measurement system of claim 12, in which the simulation model is a circuit simulation model, and wherein the at least one parameter is selected from the group consisting of: resistance, impedance, temperature coefficient, parasitic capacitance, transmission line length, transmission line width, material dielectric constant, and geometry.

16. The test and measurement system of claim 12, further comprising a memory configured to store the simulation model.

17. The test and measurement system of claim 16, wherein the one or more processors are further configured to:
further improve the simulation model based at least in part on the at least one received predicted value for the improved simulation model.

18. The test and measurement system of claim 12, wherein the machine learning facility is structured to operate on one of the one or more processors of the test and measurement instrument.

19. The test and measurement system of claim 12, wherein the machine learning facility is structured to operate a processor separate from the one or more processors of the test and measurement instrument.

20. The test and measurement system of claim 12, wherein the simulation model is a circuit simulation model, a three-dimensional electromagnetic model, a serial data link simulation model, a thermal simulation model, or a motion simulation model.
